(19) United States
(12) Patent Application Publication
(10) Pub. No.: US 2022/0030037 A1
(43) Pub. Date: Jan. 27, 2022

(54) SESSION DATA PROCESSING METHOD AND APPARATUS, USER TERMINAL, AND STORAGE MEDIUM

(71) Applicant: Tencent Technology (Shenzhen) Company Limited, Shenzhen (CN)

(72) Inventors: Liqiang LIU, Shenzhen (CN); Dan He, Shenzhen (CN); Xuan Luo, Shenzhen (CN)

(21) Appl. No.: 17/498,605

(22) Filed: Oct. 11, 2021

Related U.S. Application Data
(63) Continuation of application No. PCT/CN2020/108562, filed on Aug. 12, 2020.

(30) Foreign Application Priority Data
Aug. 16, 2019 (CN) 201910760786.X

(51) Int. Cl. H04L 29/06; H04L 12/58

(52) U.S. Cl. CPC H04L 65/1016; H04L 65/1086; H04L 51/04; H04L 51/16; H04L 65/1003

(57) ABSTRACT

This application discloses a session data processing method performed at a computing device. The method includes: obtaining, in response to a first reply operation performed on first session data on a primary session page, second session data, and generating a set creation instruction for the first session data; transmitting the set creation instruction and the second session data to a server; creating, in response to an expansion operation performed on the set entry, a session set page corresponding to the session set on the primary session page, and transmitting an obtaining instruction to the server; and receiving the session set from the server, and outputting session data in the session set on the session set page, the session set including the first session data and at least one piece of second session data, and each piece of second session data having a reply association relationship with the first session data.

### CROSS-REFERENCE TO RELATED APPLICATIONS

This application is a continuation application of PCT Patent Application No. PCT/CN2020/108562, entitled “SESSION DATA PROCESSING METHOD AND APPARATUS, USER TERMINAL, AND STORAGE MEDIUM” filed on Aug. 12, 2020, which claims priority to Chinese Patent Application No. 201910760786.X, filed with China National Intellectual Property Administration on Aug. 16, 2019 and entitled “SESSION DATA PROCESSING METHOD AND APPARATUS AND COMPUTER-READABLE STORAGE MEDIUM”, all of which are incorporated herein by reference in their entireties.

### FIELD OF THE TECHNOLOGY

This application relates to the technical field of data processing, and in particular, to a session data processing method and apparatus, a user terminal, and a storage medium.

### BACKGROUND OF THE DISCLOSURE

With continuous development of computer networks, various messaging applications have emerged. A messaging application generally has a group chat function. When there are too many users in a group chat, there are also many messages in the group chat. Therefore, this puts forward more requirements on the group chat function of the messaging application.

In current technologies, a message is usually displayed on a group chat page according to a time at which the message is received. Therefore, a user can only sequentially browse all messages on the group chat page by sliding upwards and downwards on the group chat page regardless of what topic each message relates to and whether such topic is of interest to the user or not. When there are too many messages on the group chat page, it is very difficult for the user to quickly find and view a desired message, resulting in low efficiency in browsing group chat messages.

### SUMMARY

The embodiments of this application provide a session data processing method and apparatus, a user terminal, and a storage medium, which can increase display modes of session data and improve browsing efficiency of session data.

According to an aspect of the embodiments of this application, a session data processing method is provided, performed by a computing device (e.g., user terminal), the method including:

obtaining, in response to a first reply operation performed on first session data on a primary session page, second session data that has a reply association relationship with the first session data, and outputting a set entry of a session set corresponding to the first session data on the primary session page, and generating a set creation instruction for the first session data and the second session data;

transmitting the set creation instruction and the second session data to a server, wherein the server determines the session set according to the set creation instruction, the session set including the first session data and the second session data;

creating, in response to an expansion operation performed on the set entry, a session set page corresponding to the session set on the primary session page, and transmitting an instruction to the server for obtaining session information associated with the session set; and

receiving the session information associated with the session set from the server, and outputting session data in the session set on the session set page, the session set comprising the first session data and at least one piece of the second session data, and each piece of the second session data having a reply association relationship with the first session data.

According to another aspect of the embodiments of this application, a computing device is provided, including: a processor and a memory;

the processor being connected to the memory, the memory being configured to store a plurality of computer programs that, when executed by the processor, cause the computing device to perform the method according to the foregoing aspect of the embodiments of this application.

According to an aspect of the embodiments of this application, a non-transitory computer-readable storage medium is provided, storing a plurality of computer programs, the computer programs including program instructions that, when executed by a processor of a computing device, causing the computing device to perform the method according to the foregoing aspect.

### BRIEF DESCRIPTION OF THE DRAWINGS

To describe the technical solutions of this application or the related technology more clearly, the following briefly introduces the accompanying drawings required for describing the embodiments or the related technology. The accompanying drawings in the following description show some embodiments of this application, and a person skilled in the art may still derive other drawings from these accompanying drawings without creative efforts.

FIG. 1 is a schematic architectural diagram of a system according to an embodiment of this application;

FIG. 2 is a schematic diagram of an interface of a terminal according to this application;

FIG. 3A is a schematic flowchart of a session data processing method according to an embodiment of this application;

FIG. 3B is a schematic flowchart of another session data processing method according to an embodiment of this application;

FIG. 3C is a schematic flowchart of still another session data processing method according to an embodiment of this application;

FIG. 4 is a schematic diagram of a scenario in which an identifier is added according to an embodiment of this application;

FIG. 5 is a schematic flowchart of another session data processing method according to an embodiment of this application;

FIG. 6 is a schematic diagram of an interface of another terminal according to an embodiment of this application;

FIG. 7 is a schematic diagram of an interface of another terminal according to an embodiment of this application;

FIG. 8 is a schematic diagram of an interface of another terminal according to an embodiment of this application;

FIG. 9 is a schematic diagram of an interface of another terminal according to an embodiment of this application;

FIG. 10 is a schematic diagram of an interface of another terminal according to an embodiment of this application;

FIG. 11 is a schematic diagram of an interface of another terminal according to an embodiment of this application;

FIG. 12 is a schematic diagram of an interface of another terminal according to an embodiment of this application;

FIG. 13 is a schematic diagram of an interface of another terminal according to an embodiment of this application;

FIG. 14 is a schematic diagram of an interface of another terminal according to an embodiment of this application;

FIG. 15 is a schematic structural diagram of a session data processing apparatus according to an embodiment of this application;

FIG. 16 is a schematic structural diagram of another session data processing apparatus according to an embodiment of this application; and

FIG. 17 is a schematic structural diagram of a user terminal according to an embodiment of this application.

### DESCRIPTION OF EMBODIMENTS

The technical solutions of this application are clearly and completely described below with reference to the accompanying drawings of this application. Apparently, the described embodiments are merely some rather than all of the embodiments of this application. All other embodiments obtained by a person of ordinary skill in the art based on the embodiments of this application without creative efforts shall fall within the protection scope of this application.

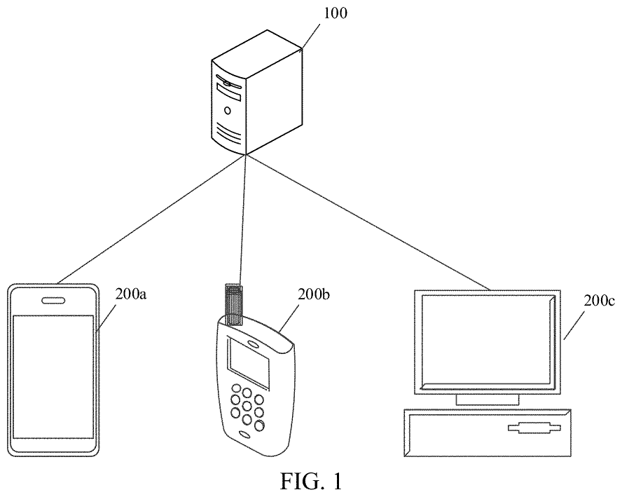

FIG. 1 is a schematic architectural diagram of a system according to an embodiment of this application. As shown in FIG. 1, the schematic structural diagram of the system includes a server 100, a terminal 200a, a terminal 200b, and a terminal 200c. The server 100 may communicate with the terminal 200a, the terminal 200b, and the terminal 200c. Herein, communication between the server 100 and the terminal 200a is used as an example to describe the embodiments of this application. Herein, the communication between the terminal 200a and the server 100 is mainly used as an example for description.

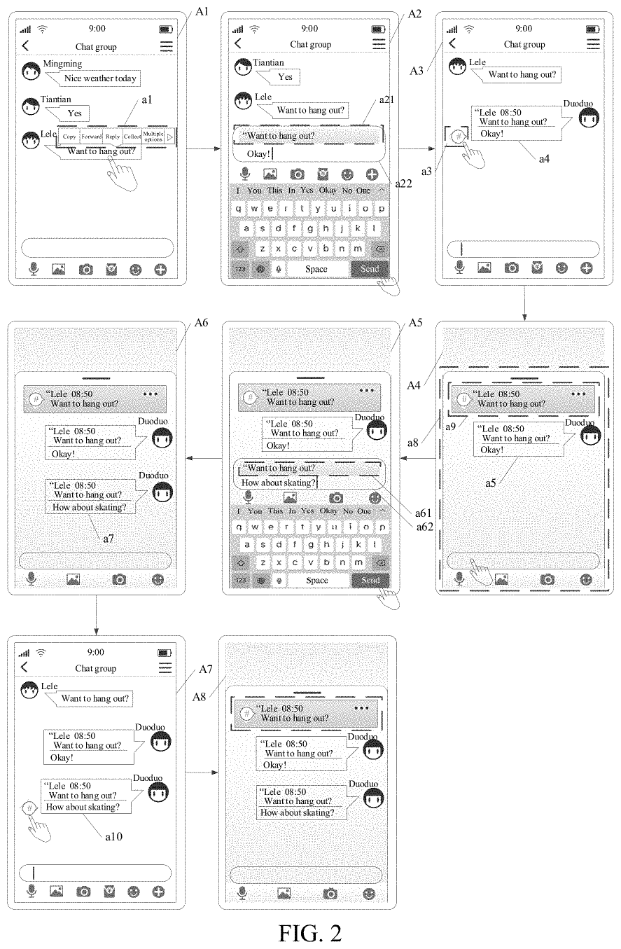

FIG. 2 is a schematic diagram of an interface of a terminal according to an embodiment of this application. As shown in FIG. 2, a page A1, a page A2, a page A3, a page A4, a page A5, and a page A6 are 6 pages of the terminal 200a, and the terminal 200a is a terminal corresponding to a user “Duoduo”. The page A1 is a group chat page corresponding to a group “chat group”. The page A1 displays 3 group chat messages sent by 3 users: a group chat message “nice weather today” sent by a user “Mingming”, a group chat message “yes” sent by a user “Tiantian”, and a group chat message “Want to hang out?” sent by a user “Lele”. The terminal 200a may display a menu bar al in an area of the message “Want to hang out?” (which may be an area above the message “Want to hang out?”) in response to a user operation performed by the user “Duoduo” on the group chat message “Want to hang out?” on the page A1, as shown on the page A1.

The terminal 200a may display, in response to a user operation performed on a “reply” menu in the menu bar al, a message entering box including an object that invites replies (which is also referred to as “to-be-replied object”), where the to-be-replied object is the group chat message “Want to hang out?”, that is, a message entering box a22 including a to-be-replied object a21 displayed on the page A2. At the same time, the terminal 200a generates a set creation instruction. When the user “Duoduo” enters a message “Okay!” in the message entering box a22 on the page A2, and clicks on a “send” key on a keyboard on the page A2, the terminal 200a may obtain the message “Okay!” entered by the user “Duoduo”. The terminal 200a may send the generated set creation instruction and the obtained message “Okay!” to the server 100. At the same time, the terminal 200a may output (that is, display) the obtained reply message “Okay!” on the group chat page of the chat group, that is, a message a4 outputted on the group chat page of the page A3.

In addition to the reply message “Okay!”, the message a4 further includes the to-be-replied object (that is, the message “Want to hang out?”) of the reply message “Okay!”, a time at which the to-be-replied object is obtained (that is, a time at which the message “want to hang out?” is obtained is 8:50), and a set entry a3. The set entry a3 is used to obtain a session set, and the session set is created according to the to-be-replied message “Want to hang out?” and the reply message “Okay!”.

The server 100 may create the session set according to the obtained set creation instruction. The session set includes the to-be-replied message “Want to hang out?” and the reply message “Okay!”. The terminal 200a may create a session set page in response to a user operation performed on the set entry a3, where the session set page is used to output all messages in the session set. At the same time, the terminal 200a generates an instruction for obtaining session information associated with the session set, and sends the obtaining instruction to the server 100. When receiving the obtaining instruction sent by the terminal, the server 100 obtains the session information associated with the session set, and sends the obtained session set to the terminal 200a. In some embodiments, the session information includes identification information of the session set and each individual piece of session data in the session set.

The terminal 200a may output, on the created session set page, a message in the received session set sent by the server 100, as shown on a session set page a8 on the page A4. The session set page a8 is a chat page corresponding to the session set. The session set page a8 may be a sub-page (which may be a half-screen floating layer, a pop-up window, or a floating window) independently displayed on the group chat page of the chat group. A title bar a9 in the session set page a8 displays the to-be-replied message “Want to hang out?”. The reply message “Okay!”, that is, a message a5, is displayed below the title bar a9 of the session set page a8. The message a5 also displays the to-be-replied object, that is, the message “Want to hang out?”. The terminal 200a may obtain and display, on the session set page a8, all messages that have a reply association relationship with the initial to-be-replied message “Want to hang out?”.

For example, the message “Want to hang out?” is referred to as a message 1, and the message “Okay!” is referred to as a message 2. A to-be-replied object of the message 2 is the message 1. When a to-be-replied object of a message 3 is the message 2, and a to-be-replied object of a message 4 is the message 3, the message 4, the message 3, and the message 2 all have a reply association relationship with the message 1. A chain may be used to further illustrate messages that have a reply association relationship with the message 1, that is, a chain 1:

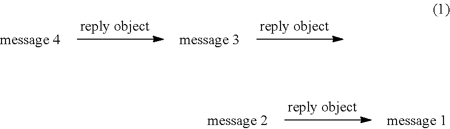

A chain 2 may be derived from the chain 1:

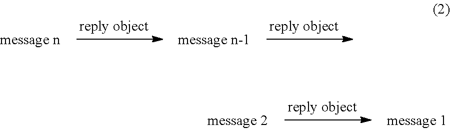

On the chain 2, all messages except the message 1 have a reply association relationship with the message 1, that is, the message 2 to a message n all have a reply association relationship with the message 1.

The user is supported to enter, on the session set page a8, a message that has a reply association relationship with the message “Want to hang out?”. The terminal may display, on the session set page a8 in response to a user operation performed on the entering box on the session set page a8, the keyboard and a message entering box a62 that includes the to-be-replied object, that is, the message “Want to hang out?” (as shown on the page A5, the message entering box automatically displays a to-be-replied object a61). When the user “Duoduo” enters, in the message entering box of the page A5, a message “How about going skating?” and clicks on the “send” key on the keyboard on the page A5, the terminal 200a may obtain the message “How about going skating?”, and send the message entering box a62 “How about going skating?” that includes the to-be-replied object a61 to the chat page of the session set, as shown in a message a7 on the page A6. The message a7 is the message “How about going skating?” sent by the user “Duoduo”, and the message a7 includes the to-be-replied object a61 (that is, the message “Want to hang out?” of the user Lele) of the message “How about going skating?”. The message “How about going skating?” also has a reply association relationship with the message “Want to hang out?”. At the same time, the terminal 200a sends the obtained message “How about going skating?” to the server 100, and the server 100 adds the received message “How about going skating?” to the session set created previously.

In addition, the terminal 200a may also use the message “How about going skating?” in the message a7 as a to-be-replied object in response to a user operation (such as a click operation) performed on the message a7 on the page A6, and obtain, on the session set page of the page A6, a message whose to-be-replied object is the message “How about going to skating?”. The message whose to-be-replied object is the message “how about going to skating?” is referred to as a selected reply message. The terminal 200a may display, on the session set page, the selected reply message including the to-be-replied object. At the same time, the terminal 200a also sends the obtained selected reply message to the server 100, and the server 100 also adds the received selected reply message to the session set previously created. Therefore, the session set in the server 100 includes the message “Want to hang out?” and all messages that have a reply association relationship with the message “Want to hang out?”.

Based on the page A6, the terminal 200a may close the session set page in response to a closing operation performed on the session set page of the page A6, and display the group chat page of the chat group, as shown on the page A7. Messages obtained on the chat page of the session set (for example, the foregoing session set page a8) are also sequentially displayed on the group chat page of the chat group. For example, according to a time at which a message is obtained, messages obtained on the group chat page of the chat group and messages obtained on the session set page may be sequentially outputted on the group chat page of the chat group (that is, sequentially displayed). As shown on the page A7, the group chat page of the page A7 displays the message “Okay!” whose to-be-replied object is the message “Want to hang out?” and the message “How about going skating?” (that is, a message a10) whose to-be-replied object is also the message “Want to hang out?” that are obtained on the session set page. In addition, the set entry originally carried by the message “Okay!” (for example, the set entry carried by the message a4 on the page A3) is now carried by the obtained latest message a10, that is, an obtained latest message that is in the session set and has a reply association relationship with the message “Want to hang out?” is used as an object carrying the set entry.

In some embodiments, each message that has a reply association relationship with the message “Want to hang out?” on the group chat page may carry a set entry. When a user clicks on a set entry, the terminal 200a may create a session set page, and correspondingly display, on the session set page, a message corresponding to the set entry that is clicked on, that is, jump to display a position of the message corresponding to the set entry that is clicked on.

The terminal may create a session set page in response to a user operation performed on the set entry carried by the message a10 on the page A7, and generate an obtaining instruction and send the obtaining instruction to the server 100. The server 100 may obtain the session set according to the received obtaining instruction. In this case, the session set includes the message “Want to hang out?”, the message “Okay!”, and the message “How about going skating?”. The server 100 sends the obtained session set to the terminal 200a, and the terminal 200a may display, on the created session set page, all the messages in the session set sent by the server, as shown on the page A8. The session set page of the page A8 displays the message “Want to hang out?”, the message “Okay!” including the to-be-replied object, and the message “How about going skating?” including the to-be-replied object in the session set.

Through the above operations, all the messages that have a reply association relationship with the message “Want to hang out?” are aggregately displayed on the session set page. A session set created by the message “Want to hang out?” may be understood as a small topic or a small discussion, and users are supported to conduct conversation together about this small topic on the session set page.

The above user operation performed on the group chat message “Want to hang out?” on the page A1, the user operation performed on the “reply” menu, the user operation performed on the set entry a3, the user operation performed on the entering box on the session set page a8, the user operation performed on the message a7, and the user operation performed on the set entry carried by the message a10 may be any one of a click operation, a sliding operation, a double-tap operation, a long-press operation, and an operation of sliding in two directions with two fingers at the same time. A specific operation form of the user operation is determined according to an actual application scenario, and is not limited herein.

When creating a session set in a group chat, the server broadcasts the session set to devices and/or user accounts corresponding to all users in the group chat, that is, all the users in the group chat can view the session set and participate in the session set. In other words, all related user operations performed on the session set by the user Duoduo can be implemented by each other user in the group chat, except that devices and/or user accounts of entered user operations performed on the session set are different.

In a method provided in the embodiments of this application, a user in a group chat can be supported to aggregately view and reply messages of a plurality of topics in the group chat without affecting the group chat. For example, when a group chat includes both a topic “Where to go?” and a topic “When to go?”, a session set may be created for each of the two topics, and users are supported to discuss related matters on session set pages respectively corresponding to the two session sets. To be specific, discussion of the two topics does not affect each other and is independent of each other, but a group chat page (for example, the foregoing page A1, the page A3, and the page A7) of the group chat simultaneously displays messages obtained on session set pages respectively corresponding to the two topics. Therefore, this can help users better manage, find, and read all messages about the same topic.

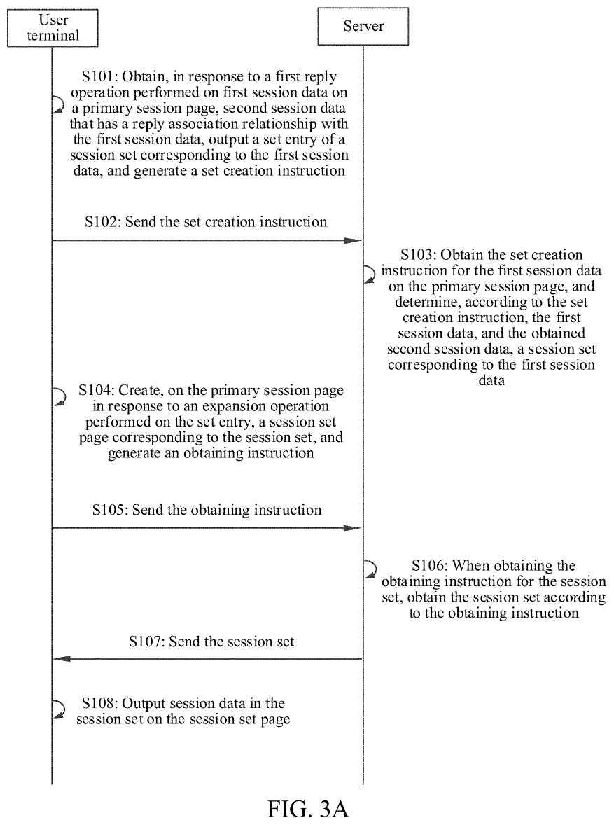

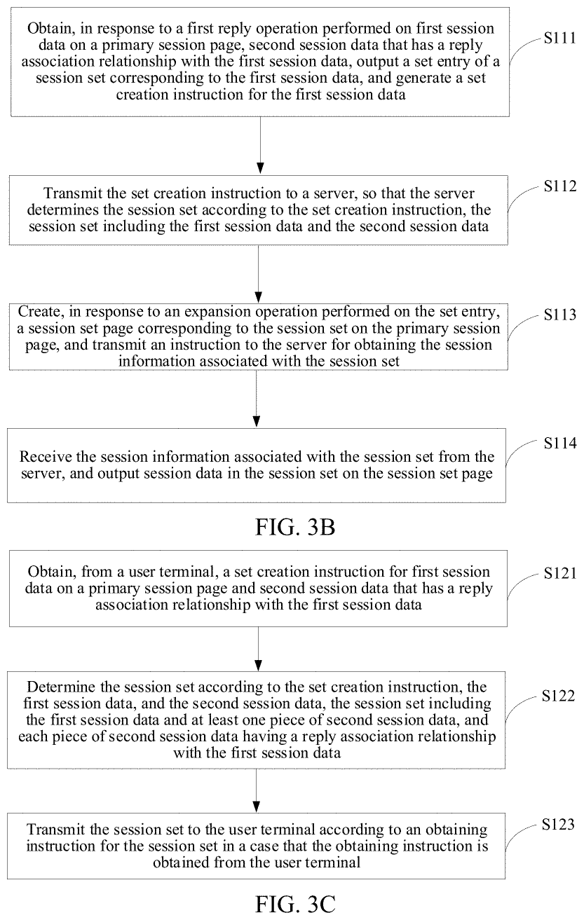

FIG. 3A is a schematic flowchart of a session data processing method according to an embodiment of this application. As shown in FIG. 3A, the method is applied to a user terminal and a server to reflect interaction therebetween. For example, any one of the terminals 200a, 200b, and 200c shown in FIG. 1 is used as a user terminal to interact with the server 100 shown in FIG. 1. Specifically, the method may include:

Step S101: The user terminal obtains, in response to a first reply operation performed on first session data on a primary session page, second session data that has a reply association relationship with the first session data, outputs a set entry of a session set corresponding to the first session data, and generates a set creation instruction.

Specifically, if the user terminal is a terminal corresponding to a first user of a social networking application (e.g., an instant messaging application), the user terminal may respond to a first reply operation performed by the first user on first session data on the primary session page. The primary session page may be a chat page between the first user and another friend or another user of the social networking application, or a group chat page (for example, the page A1, the page A3, or the page A7 in FIG. 2) of the first user in a group chat of the social networking application. The first session data may be any session data on the primary session page, session data is a chat message, and one piece of session data may be understood as one message, that is, the first session data may be any message sent by another user or any message sent by the first user on the primary session page. For example, the first session data may be the message “nice weather today”, the message “yes”, or the message “Want to hang out?” on the page A1.

The first reply operation is a reply operation performed by the first user on the first session data. For example, the user operation performed on the group chat message “Want to hang out?” and the user operation performed on the “reply” menu on the page A1 may be collectively referred to as the first reply operation. Correspondingly, the first session data is the group chat message “Want to hang out?” on the page A1, that is, the first reply operation may be performed to reply to the first session data as the to-be-replied object.

The user terminal may output, in response to the first reply operation performed by the first user on the first session data, a set entry of a session set corresponding to the first session data. The set entry is used to trigger the user terminal to obtain the session set and create a session set page for the session set. At the same time, the user terminal also generates a set creation instruction.

When the first session data is text-type data, the user terminal may further obtain reply session data of the first user for the first session data in response to the first reply operation performed by the first user on the first session data, which may be referred to as first reply session data, as second session data. The first reply session data carrying the set entry may be outputted on the primary session page.

The user terminal may output the set entry on the primary session page. The user terminal may separately output a set entry, or may output a set entry through the first reply session data. For example, the user terminal may output, on the primary session page, the first reply session data (for example, the message a4 carrying the set entry a3 in FIG. 2, where the message a4 is the first reply session data, the message a4 is the message “Okay!” whose to-be-replied object is the first session data, and the message “Want to hang out?” is the first session data) carrying the set entry.

Step S102: The user terminal sends the set creation instruction to the server.

Specifically, the user terminal sends the foregoing set creation instruction generated through the first reply operation to the server, and the user terminal may also send the obtained first reply session data to the server. Each time the user terminal obtains one piece of session data, the user terminal sends the obtained session data to the server.

Step S103: The server obtains the set creation instruction for the first session data on the primary session page, and determines, according to the set creation instruction, the first session data, and the obtained second session data, a session set corresponding to the first session data.

Specifically, the server obtains the set creation instruction sent by the user terminal, and creates the session set according to the set creation instruction. Specifically, the server generates a session set identifier (which may be understood as creating a session set), and separately sets identifier information for the first session data and all the second session data. The identifier information includes the foregoing session set identifier. That is, the server sets the session set identifier for the first session data and all the second session data. One session set corresponds to one session set identifier. Session data for which the same session set identifier is set belongs to the same session set. A session set identifier of a session set and a session set identifier of session data in the session set are the same, that is, the identifier corresponding to the session set is also the foregoing session set identifier. The foregoing second session data is session data that has a reply association relationship with the first session data. Herein, the second session data includes the first reply session data. The server may set the session set identifier for the first session data and the first reply session data, which indicates that the first session data and the first reply session data belong to the same session set, that is, the session set corresponding to the first session data includes all session data (including the first session data and the first reply session data herein) for which the foregoing session set identifier is set.

The identifier information set by the server for the first session data and the second session data may further include an identifier of a sending object (or an identifier of a sender), an identifier of a to-be-replied object (or an identifier of a reference message), and an identifier of session data (or an identifier of a topic). The identifier of the sending object represents a user sending the session data. For example, a sending object of the message “nice weather today” on the page A1 in FIG. 2 is the user Mingming. The identifier of the to-be-replied object represents the session data to which the session data replies. For example, a to-be-replied object of the message a4 “Okay!” on the page A3 in FIG. 2 is the message “want to hang out?” of the user Lele. The identifier of the session data is a unique identifier corresponding to one piece of session data. A session data identifier of a piece of session data may be understood as an ID card number of the session data.

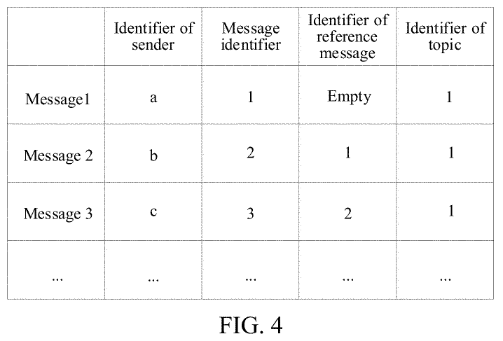

For example, FIG. 4 is a schematic diagram of a scenario in which an identifier is added according to an embodiment of this application. A message 1 is the first session data, and a message 2 and a message 3 are the second session data corresponding to the first session data. The identifier is an ID (an identifier). Identifier information set by the server for the message 1 includes that: an identifier of a sender is a (that is, an identifier of a sending object is a), a message identifier is 1 (that is, an identifier of session data is 1), an identifier of a reference message is empty (that is, an identifier of a to-be-replied object is empty, indicating that the message 1 does not refer to another message), and an identifier of a topic is 1 (indicating that an identifier of a session set is 1). Identifier information set by the server for the message 2 includes that: an identifier of a sender is b (that is, an identifier of a sending object is b), a message identifier is 2 (that is, an identifier of session data is 2), an identifier of a reference message is 1 (that is, an identifier of a to-be-replied object is 1, indicating that a to-be-replied object of the message 2 is the message 1), and an identifier of a topic is 1 (indicating that an identifier of a session set is 1). Identifier information set by the server for the message 3 includes that: an identifier of a sender is c (that is, an identifier of a sending object is c), a message identifier is 3 (that is, an identifier of session data is 3), an identifier of a reference message is 2 (that is, an identifier of a to-be-replied object is 2, indicating that a to-be-replied object of the message 3 is the message 2), and an identifier of a topic is 1 (indicating that an identifier of a session set is 1).

The first session data may alternatively have more second session data. Herein, only an example in which only the message 2 and the message 3 are used as the second session data of the message 1 is used for description. Session set identifiers of the message 1, the message 2, and the message 3 are all 1, which indicates that the message 1, the message 2, and the message 3 belong to the same session set. In addition, because the message 1 is session data that is referred to at the beginning, the message 1 is replied to and has no to-be-replied object, that is, the reference message is empty. The to-be-replied object of the message 2 is the message 1, and the to-be-replied object of the message 3 is the message 2. The identifier of the sender may be a user identifier, that is, the message 1 is sent by a user a, the message 2 is sent by a user b, and the message 3 is sent by a user c.

A session data identifier of session data may be associated with an identifier of a corresponding sending object, an identifier of a corresponding to-be-replied object, and an identifier of a corresponding session set. The sending object, the to-be-replied object, and the session set that correspond to the session data may be represented and searched for by using the identifier of the sending object, the identifier of the to-be-replied object, and the identifier of the session set that are associated with the session data identifier of the session data.

The server may store, in a database, session data for which identifier information (including a session set identifier) has been set, that is, the server may store, in the database, the session set for which the identifier information has been set. The session set for which the identifier information has been set is a session data set including the first session data for which the identifier information has been set and the second session data for which the identifier information has been set.

Step S104: The user terminal creates, on the primary session page in response to an expansion operation performed on the set entry, a session set page corresponding to the session set, and generates an obtaining instruction.

Specifically, the user terminal may create, in response to the expansion operation performed on the set entry on the primary session page, for example, an expansion operation performed on the set entry a3 on the page A3 in FIG. 2 (which may be a click operation performed on the set entry a3), the session set page corresponding to the session set, and generate the obtaining instruction.

When the first reply session data on the primary session page carries the set entry, the user terminal may create, in response to the expansion operation performed on the set entry that is carried by the first reply session data, the session set page corresponding to the session set, the session set page being a sub-page that is independently displayed on the primary session page, and generate the obtaining instruction. The created session set page is used to display session data in the session set, and more second session data may be obtained on the session set page. The generated obtaining instruction is used to obtain the session set.

Step S105: The user terminal sends the instruction to the server for obtaining session information associated with the session set to the server.

Specifically, the user terminal may send the generated obtaining instruction to the server.

Step S106: When obtaining the obtaining instruction for the session set, the server obtains the session information associated with the session set according to the obtaining instruction.

Specifically, the session set identifier of the session set may be carried by the obtaining instruction. When obtaining the obtaining instruction for the session set, the server may pull, according to the session set identifier carried by the obtaining instruction, the session set corresponding to the session set identifier in the database. For example, when the session set identifier carried by the obtaining instruction is 1, the server may pull all session data for which the session set identifier 1 is set in the database, to serve as the foregoing session set. When the session data for which the session set identifier 1 is set includes the message 1 and the message 2, the session set obtained by the server includes the message 1 and the message 2.

In addition, when identifier information set by the server for each piece of session data further includes an identifier of a sending object, an identifier of a to-be-replied object, and an identifier of session data, the server may find, based on the session set identifier carried by the obtaining instruction, a session data identifier corresponding to each piece of session data for which the same session set identifier is set, and then find, based on the session data identifier corresponding to each piece of session data, an identifier of a sending object and an identifier of a to-be-replied object that are associated with each piece of session data. The server may correspondingly obtain, based on the found identifier of the sending object and the found identifier of the to-be-replied object that are associated with each piece of session data, the sending object and the to-be-replied object that correspond to each piece of session data. The sending object is obtained based on the corresponding identifier of the sending object, and the to-be-replied object is obtained based on the corresponding identifier of the to-be-replied object.

For example, the server finds, based on the session set identifier 1 carried by the obtaining instruction, the message 1, the message 2, and the message 3 for which the same session set identifier 1 is set. Then, the server finds that the identifier of the sending object of the message 1 is a and the identifier of the to-be-replied object is empty based on the session data identifier 1 of the message 1. Therefore, the server may obtain that the sending object of the message 1 is the user a, the message 1 has no to-be-replied object, and the message 1 is the first session data. The server finds that the identifier of the sending object of the message 2 is b and the identifier of the to-be-replied object is 1 based on the session data identifier 2 of the message 2. Therefore, the server may obtain that the sending object of the message 2 is the user b, the to-be-replied object of the message 2 is the message 1, and the message 2 is the second session data of the message 1. The server finds that the identifier of the sending object of the message 3 is c and the identifier of the to-be-replied object is 2 based on the session data identifier 3 of the message 3. Therefore, the server may obtain that the sending object of the message 3 is the user c, the to-be-replied object of the message 3 is the message 2, and the message 3 is the second session data of the message 1.

Step S107: The server sends the session set to the user terminal.

Specifically, the server may send the obtained session set to the user terminal. In addition to including the first session data and the second session data, the session set sent by the server to the user terminal may also include a sending object and a to-be-reply object that correspond to each piece of session data in the session set. For example, when the session set obtained by the server includes the message 1, the message 2, and the message 3, the session set sent by the server to the user terminal may include the message 1, the sending object and the to-be-reply object that correspond to the message 1, the message 2, the sending object and the to-be-reply object that correspond to the message 2, the message 3, and the sending object and the to-be-reply object that correspond to the message 3.

Step S108: The user terminal outputs the session data in the session set on the session set page.

Specifically, the user terminal may output (that is, display), on the created session set page, all session data in the session set sent by the server to the user terminal. Each piece of session data outputted by the user terminal on the session set page may also include a sending object and a to-be-reply object that correspond to each piece of session data.

For example, on the page A4 in FIG. 2, the outputted message a5 includes the original content “Okay!” of the message, and the sending object “Duoduo” and the to-be-reply object “Want to hang out?” that correspond to the message “Okay!”. A user is supported to enter more session data on the session set page, and the session data entered by the user on the session set page is all the second session data, that is, messages entered by the user on the session set page all have a reply association relationship with the first session data. All the messages entered by the user on the session set page are also outputted on the primary session page, that is, the user terminal may output all the second session data in the session set on the primary session page.

The user terminal may obtain an entry time of each piece of session data (including the first session data and the second session data) in the session set. The entry time is a time at which the session data is added to the session set, that is, may be a time at which the user terminal obtains the session data sent by the user. The user terminal may use session data with a latest entry time (referring to obtained latest session data, that is, obtained last session data) in the session set as carrying session data. The user terminal may delete a set entry of a session set existing on the primary session page, and output, on the primary session page, the carrying session data carrying the set entry.

The user terminal may sequentially output, on the primary session page, each piece of second session data in the session set according to the entry time of each piece of second session data in the session set, that is, an output time of each piece of second session data on the primary session page is the same as the entry time at which the second session data is added to the session set. In the method provided in this embodiment of this application, it is ensured that the user is supported to chat about a targeted topic on the session set page without affecting the overall group chat of the user.

In some embodiments, the user may also reply to the session data in the session set outputted on the primary session page, and a message with which the user replies to the session data in the session set on the primary session page is also the second session data in the session set. For example, the user is supported to reply to the message “Okay!” whose to-be-reply object is the message “Want to hang out?” on the page A7 in FIG. 2.

When the user long-presses the message “Okay!” on the page A7, a menu bar (which is the same as the menu bar al) may pop up on the terminal 200a. When the user clicks on a “reply” menu in the menu bar, the terminal 200a may display, on a current page, a message entry page (including a message entering box and a keyboard, where the to-be-reply object is the message “Okay!”) including the to-be-reply object, that is, the message “Okay!”, and obtain, on the message entry page,

second session data that is entered by the user and whose to-be-reply object is “Okay!”. The second session data and the message “Okay!” on the page A7 belong to the same session set. The user terminal may output, on the primary session page, the second session data obtained on the primary session page. At the same time, the user terminal may display, on the session set page, the second session data obtained on the primary session page. The second session data obtained on the primary session page and the second session data obtained on the session set page are sequentially outputted and displayed on the session set page according to an entry time of the second session data obtained on the primary session page and an entry time of the second session data obtained on the session set page.

FIG. 3B is a schematic flowchart of another session data processing method according to an embodiment of this application. As shown in FIG. 3B, the method is applied to a user terminal. For example, any one of the terminals 200a, 200b, and 200c shown in FIG. 1 is used as a user terminal. Specifically, the method may include:

Step S111: Obtain, in response to a first reply operation performed on first session data on a primary session page, second session data that has a reply association relationship with the first session data, output a set entry of a session set corresponding to the first session data, and generate a set creation instruction for the first session data.

Step S112: Transmit the set creation instruction and the second session data to a server, so that the server determines the session set according to the set creation instruction, the session set including the first session data and the second session data.

For descriptions of steps S111 and S112, refer to the description of step S101, which is not repeated herein.

Step S113: Create, in response to an expansion operation performed on the set entry, a session set page corresponding to the session set on the primary session page, and transmit an instruction to the server for obtaining session information associated with the session set.

For description of this step, refer to the descriptions of step S104 and step S105, which is not repeated herein.

Step S114: Receive the session information associated with the session set from the server, and output session data in the session set on the session set page, the session set including the first session data and at least one piece of second session data, and each piece of second session data having a reply association relationship with the first session data.

For description of this step, refer to the descriptions of step S107 and step S108, which is not repeated herein.

As can be seen, in the method provided in this embodiment of this application, the session data that has a reply association relationship with the first session data may be aggregately displayed on the session set page, which can increase display modes of session data and improve browsing efficiency of session data.

FIG. 3C is a schematic flowchart of a session data processing method according to an embodiment of this application. As shown in FIG. 3C, the method is applied to a server, for example, the server 100 shown in FIG. 1. Specifically, the method may include:

Step S121: Obtain, from a user terminal, a set creation instruction for first session data on a primary session page and second session data that has a reply association relationship with the first session data.

The user terminal obtains the second session data in response to a first reply operation performed on the first session data, and outputs a set entry of a session set corresponding to the first session data.

Step S122: Determine the session set according to the set creation instruction, the first session data, and the second session data, the session set including the first session data and at least one piece of second session data, and each piece of second session data having a reply association relationship with the first session data.

For description of this step, refer to the description of step S103, which is not repeated herein.

Step S123: Transmit the session set to the user terminal according to an obtaining instruction for the session set when the obtaining instruction is obtained from the user terminal.

The user terminal creates, on the primary session page in response to an expansion operation performed on the set entry, a session set page corresponding to the session set, and generates the obtaining instruction.

For description of this step, refer to the description of step S106, which is not repeated herein.

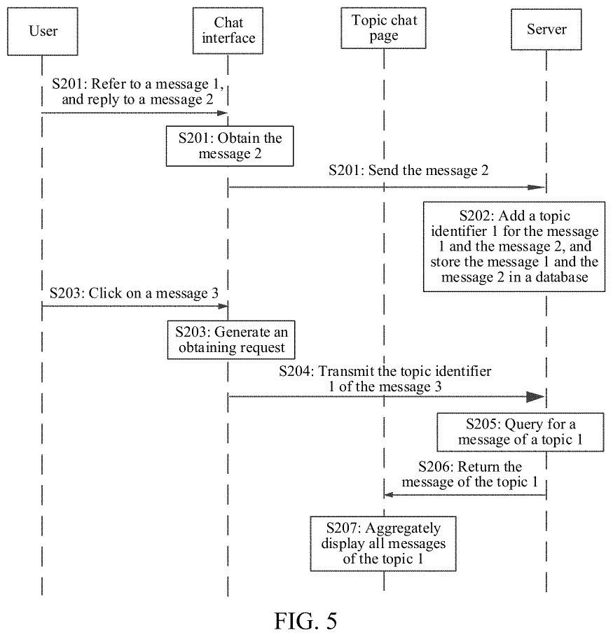

FIG. 5 is a schematic flowchart of another session data processing method according to an embodiment of this application. The session data processing method shown in FIG. 5 is applied to a user, a user terminal, and a server. For example, the user terminal in any one of the terminals 200a, 200b, and 200c shown in FIG. 1, and the server 100 shown in FIG. 1. A chat interface and a topic chat page are displayed on the user terminal. A message 1, a message 2, and a message 3 all belong to a session set whose session set identifier is 1. As shown in FIG. 5, the session data processing method includes:

Step S201: Obtain, on the primary session page, the message 2 with which the user replies to based on a reference message 1, and send the message 2 to the server.

Specifically, the chat interface is the primary session page on the user terminal, and the topic chat page is the session set page mentioned above. The user b is supported to refer to the message 1 on the primary session page (that is, the chat interface), that is, replies to the message 1 as a to-be-reply object. In addition, the message 2 is sent to the primary session page, and the to-be-reply object of the message 2 is the message 1.

Step S202: Add a topic identifier 1 for the message 1 and the message 2, and store the message 1 and the message 2 in the database.

Specifically, the user terminal sends the message 2 obtained on the chat interface to the server, the server has previously stored the message 1, and the server may add the topic identifier 1 for both the message 1 and the message 2. The topic identifier 1 indicates that the session set identifier is 1. The server may store, in the database, the message 1 and the message 2 for which the session set identifier has been added.

Step S203: Generate an obtaining request based on an operation of clicking on the message 3 by the user.

Specifically, the message 3 is also a message that refers to the message 1 or the message 2, the message 1 is first session data, and the message 3 and the message 2 are both second session data corresponding to the message 1. The user may click on the message 3 on the chat interface. In some embodiments, the message 3 on the primary session page carries a set entry. Clicking on the message 3 means clicking on the set entry carried by the message 3. When the user clicks on the set entry carried by the message 3, the user terminal may generate the obtaining request. The obtaining request carries the session set identifier 1 corresponding to the message 3.

Step S204: Send the generated obtaining request to the server.

Specifically, the message 3 also belongs to the session set, a session set identifier of the message 3 is also 1, and the topic chat page is also a chat page corresponding to the session set whose session set identifier is 1. The user terminal may transmit the topic identifier 1 of the message 3.

Step S205: The server queries for messages of a topic 1.

Specifically, the server queries, based on the session set identifier 1 carried by the obtaining request, the database for all session data for which the session set identifier 1 is added, that is, all the session data for which the session set identifier 1 is added is the messages of the topic 1.

Step S206: The server returns the messages of the topic 1.

Specifically, the server returns the queried messages of the topic 1 to the user terminal, and the user terminal may display the messages of the topic 1 on the topic chat page.

Step S207: Aggregately display all the messages of the topic 1 on the session set page.

Specifically, the user terminal may aggregately display all the messages of the topic 1 on the session set page (that is, the topic chat page) for the user b, that is, the user b may view only the messages of the topic 1 on the topic chat page. In this way, messages are displayed based on types.

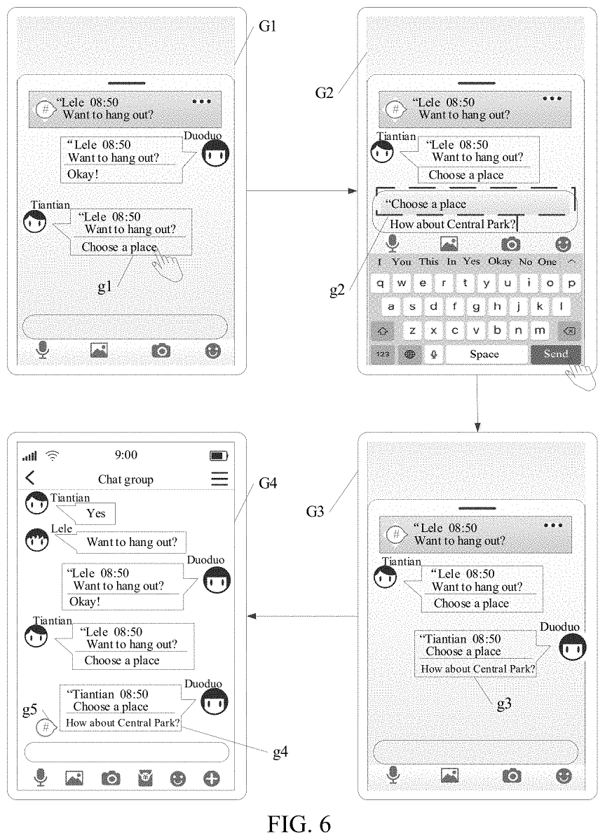

FIG. 6 is a schematic diagram of an interface of another terminal according to an embodiment of this application. As shown in FIG. 6, a page G1, a page G2, a page G3, and a page G4 are 4 pages of a user terminal. The page G1 is a page displaying a session set page. In response to a third reply operation performed on the second session data on the session set page, the user terminal may use, as a selected reply object, the second session data on which the third reply operation is performed, and display a session entry page that has the selected reply object.

For example, the second session data on the session set page of the page G1 includes a message “Okay!” and a message g1 “choose a place”. When the user clicks on the message g1 “choose a place”, the message “choose a place” may be used as a selected reply object. An operation of clicking on the message g1 “choose a place” by the user is the third reply operation. At the same time, the user terminal may display, on the session set page, a session entry page including the selected reply object “choose a place”. As shown on the page G2, the user terminal displays, on the session set page, a keyboard and a session entering box that includes a selected reply object g2 (a page formed by the session entering box and the keyboard is a session entry page).

The user terminal may obtain third reply session data in response to a session entry operation on the session entry page that has the selected reply object, the third reply session data including the selected reply object. For example, the user terminal may obtain, in response to the session entry operation (which may be a message entry operation such as a text message entry operation, a picture message entry operation, an emoji message entry operation, or a video message entry operation) on the session entry page including the selected reply object g2 on the page G2, a message “How about central park?” whose selected reply object is “choose a place”. As shown on the page G3, a message g3 is the third reply session data, and the third reply session data is the message “How about central park?” including the selected reply object “choose a place”.

The user terminal may output, on the primary session page, the third reply session data that carries the set entry. On the primary session page, obtained latest second session data may carry the set entry of the session set. The third reply session data is the obtained latest second session data. Therefore, a set entry carried by second session data obtained before the third reply session data is obtained may be deleted from the primary session page, and the third reply session data carrying the set entry is outputted on the primary session page. Herein, the second session data obtained before the third reply session data is obtained should be the message “choose a place” whose to-be-replied object is the message “want to hang out?”. That is, the message originally carrying the set entry g5 on the page G4 should be the message “choose a place” sent by the user Tiantian. The user terminal deletes the set entry carried by the message “choose a place” on the primary session page of the page G4, and displays, on the primary session page of the page G4, the message g4 “How about Central Park?” carrying the set entry g5. The message g4 is the message g3 obtained on the page G3. A session set corresponds to a set entry. In some embodiments, when the user clicks on a to-be-replied object in a message on the session set page (for example, the session set page of the page G3), the user terminal may correspondingly jump to display a position of the clicked to-be-replied object on the session set page.

In addition, the user terminal may use the first session data as a target reply object in response to a session trigger operation on the session set page, and display a session entry page that has the target reply object. The session trigger operation may be a click operation performed by the user on the entering box on the page G1. When the user clicks on the entering box on the page G1, the user terminal may automatically use the first session data as the target reply object and display the session entry page including a to-be-replied object, that is, the target reply object.

In some embodiments, when the session entry page that includes the target reply object is displayed, and when the user clicks on second session data on the session set page, the user terminal may directly switch the to-be-replied object on the session entry page from the target reply object to the clicked second session data. The user terminal may obtain second reply session data in response to a session entry operation on the session entry page that has the target reply object, the second reply session data including the target reply object. The user terminal may obtain the second reply session data on the session entry interface including the target reply object. A to-be-replied object of the second reply session data is the target reply object, and the second reply session data may include the target reply object. The user terminal may output, on the primary session page, the second reply session data that carries the set entry.

Similarly, on the primary session page, the obtained latest second session data may carry the set entry of the session set. When the session set includes only the first reply session data as second session data before the second reply session data is obtained, the user terminal may delete the set entry originally carried by the first reply session data, and output, on the primary session page, the second reply session data carrying the set entry.

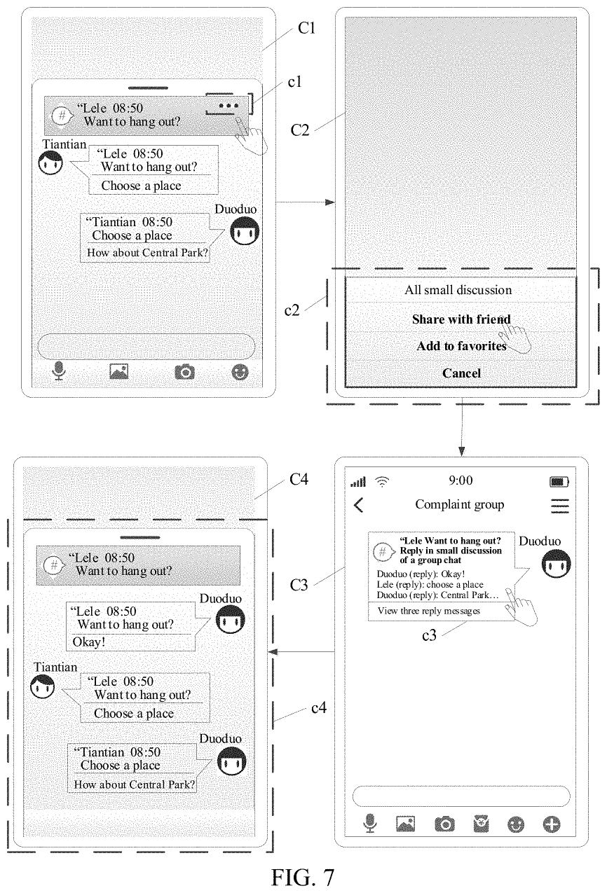

FIG. 7 is a schematic diagram of an interface of another terminal according to an embodiment of this application. A page C1, a page C2, a page C3, and a page C4 are 4 pages of a user terminal. The user terminal may generate sharing information in response to a sharing operation performed on the session set, and send the sharing information to a sharing object. That is, the user is supported to share the session set with another user. During sharing, the user shares session data currently included in the session set with the other user.

For example, when the user shares the session set at a time t1 and the session set includes 3 pieces of session data at the time t1, the 3 pieces of session data are also shared; and when the user shares the session set at a time t2 and the session set includes 5 pieces of session data at the time t2, the 5 pieces of session data are also shared. For example, the page C1 includes the session set page. When the user clicks on a button c1 on the page C1, the user terminal may display an operation menu bar c2 above the session set page. As shown on the page C2, the operation menu bar c2 includes a “share with friend” menu, an “add to favorites” menu, and a “cancel” menu. When the user clicks on the “share with friend” menu, the user terminal may generate sharing information, support the user to select one (or more than one) friend, group, or non-friend user as a sharing object through a friend selector, and send the foregoing sharing information to the sharing object. The click operation performed on the operation menu bar c2 and the click operation performed on the “share with friend” menu may be collectively referred to as sharing operations.

As shown on the page C3, the message c3 is sharing information sent by the user Duoduo in a complaint group (that is, a sharing object). The message c3 includes the message “Want to hang out?” sent by the user Lele, that is, the first session data in the session set. The message c3 may also display some second session data (which may be sequentially displayed according to times at which messages are obtained) in the session set, and herein includes the message “Okay!” replied by the user Duoduo, the message “choose a place” replied by the user Lele, and the message “Central Park . . . ” replied by the user Duoduo. The user terminal may display a session display page c4 in response to a display operation performed on the sharing information (for example, a click operation performed on the message c3). The session display page c4 is used to display session data in the session set that is shared by the user Duoduo in the complaint group.

The user terminal may further add the session set to the favorites bar in response to a collection operation performed on the session set (for example, a click operation performed on the “add to favorites” menu in the operation menu bar c2), so that it is convenient for the user to subsequently view the session data in the session set. When the user clicks on the “cancel” menu in the operation menu bar c2, the user terminal may close the operation menu bar c2. The foregoing session display page c3 and the operation menu bar c2 may be both sub-pages (which may be pop-up windows or floating windows) independently displayed on a current page.

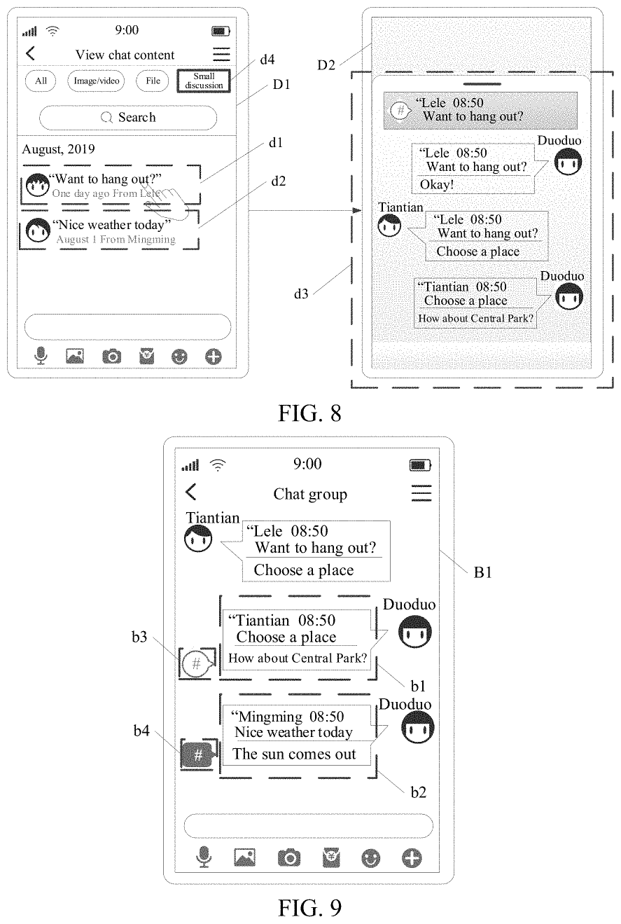

The user terminal may also use the session set as history session set data, and add the history session set data to a history session set list. FIG. 8 is a schematic diagram of an interface of another terminal according to an embodiment of this application. A page D1 and a page D2 are 2 pages of a user terminal. As shown on the page D1, a “view chat content” bar corresponding to a group chat or a chat with a friend includes a plurality of category bars of chat content: a category bar corresponding to all chat content, a category bar corresponding to image/video chat content, a category bar corresponding to file chat content, and a category bar d4 corresponding to small discussion. The category bar d4 corresponding to “small discussion” may be used to store a session set created during the chat. There may be a plurality of session sets in a group chat at the same time.

In some embodiments, timing may start when a session set is created. When timing duration reaches a duration threshold, new second session data in the session set is no longer obtained, and instead, the session set whose timing duration reaches the duration threshold is added to a history session set list as history session set data. For example, when a session set is created at 0:00 on August 8 and the duration threshold is set as 24 hours, the second session data in the session set may no longer be obtained at 0:00 on August 9, and instead, the session set is added to the history session set list as the history session set data. The category bar d4 corresponding to “small discussion” on the page D1 may be considered as a history session set list. The history session set list on the page D1 includes two session sets created on August 2019. Each of the two session sets has an information bar in the history session set list, that is, an information bar d1 and an information bar d2. As can be seen from the information bars, first session data in the session set corresponding to the information bar d1 is the message “Want to hang out?” sent by the user “Lele” one day ago, and the first session data is data that is replied to for the first time when the session set is created. First session data in the session set corresponding to the information bar d2 is the message “nice weather today” sent by the user “Mingming” on August 1. When the user clicks on an information bar of a session set, for example, clicks on the information bar d1, the user terminal may display a history session display page d3 on a current page, and the history session display page d3 displays all session data in the session set corresponding to the information bar d1.

FIG. 9 is a schematic diagram of an interface of another terminal according to an embodiment of this application. A page B1 is a primary session page corresponding to a chat group in the user terminal. The plurality of session sets may be created in a chat group at the same time. Herein, two session sets are included on the page B1, a set entry of one session set is an entry b3 carried by a message b1, and a set entry of the other session set is an entry b4 carried by a message b2. When the plurality of session sets appear in a group chat, set entries of each session set on the primary session page can be distinguished based on different colors or different styles. For example, the entry b3 is white, the entry b4 is gray, the entry b3 is circular bubble-shaped, and the entry b4 is square bubble-shaped. Distinguishing modes of different set entries are determined according to actual application scenarios, and there is no restriction herein.

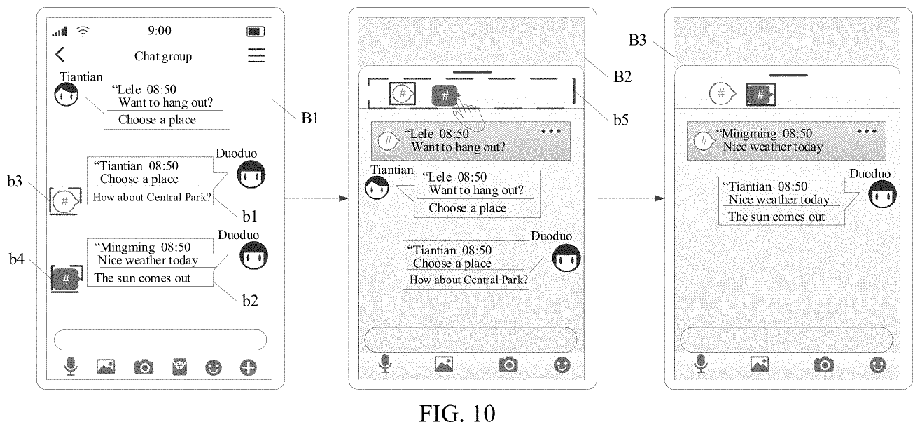

FIG. 10 is a schematic diagram of an interface of another terminal according to an embodiment of this application. A page B1 is the page B1 in FIG. 9. When the user clicks on the entry b3, the user terminal may display a session set page of the session set corresponding to the entry b3, as shown on a page B2. In addition, an area b5 on the page B2 may further display set entries corresponding to all session sets in the chat group. Herein, the area b5 displays the entry b3 and the entry b4. When the user clicks on the entry b4 in the area b5, the user terminal may switch the session set page corresponding to the current entry b3 to a session set page corresponding to the entry b4, as shown on a page B3.

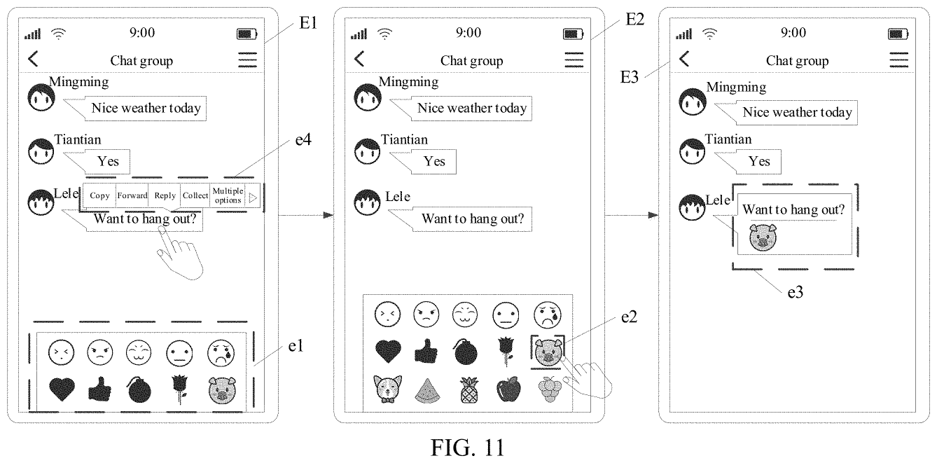

FIG. 11 is a schematic diagram of an interface of another terminal according to an embodiment of this application. A page E1, a page E2, and a page E3 are 3 pages of a user terminal. The user terminal may display a mark selection page in response to a second reply operation performed on the first session data on the primary session page, the mark selection page including a plurality of comment marks.

For example, the page E1 includes the message “Want to hang out?” sent by the user Lele. When the user long-presses the message “Want to hang out?” on the page E1, a menu bar e4 and a mark selection page e1 may be simultaneously displayed. The mark selection page e1 includes a plurality of emojis, that is, a plurality of comment marks. The long-press operation performed by the user on the message “Want to hang out?” on the page E1 is the second reply operation. The plurality of comment marks on the mark selection page e1 may be comment marks preset by a system, or comment marks collected by the user. When the user swipes upwards on the mark selection page e1 of the page E1, the mark selection page may display more comment marks. That is, the mark selection page e1 that originally displays 2 rows of comment marks may display 3 rows of comment marks, as shown on the page E2. When the user continues to swipe upwards on the mark selection page on the page E2, the mark selection page still displays 3 rows of comment marks, but the 3 rows of comment marks may be different from the comment marks on the mark selection page of the page E2, that is, more comment marks arranged after the currently displayed comment marks may be displayed.

The user terminal may determine, in response to a selection operation performed on the comment mark on the mark selection page, the comment mark corresponding to the selection operation as a target comment mark. For example, the user terminal may use, in response to a selection operation (for example, a click operation) performed on a comment mark e2 on the mark selection page of the page E2, the comment mark e2 on which the selection operation is performed as a target comment mark. The user terminal may display the target comment mark in an area of the first session data.

The area of the first session data may be an adjacent surrounding area of the first session data. For example, an area e3 may be an area of the session data “Want to hang out?”. The target comment mark, that is, the comment mark e2, may be displayed in the area e3. As shown on the page E3, the comment mark e2 on which the selection operation is performed may be displayed in the area e3 of the session data “Want to hang out?” on which the second reply operation is performed.

In some embodiments, when the user long-presses the message “Want to hang out?” on the page E1, the user terminal may first display the menu bar e4, the menu bar e4 including an “emoji” menu. Then, when the user clicks on the “emoji” menu in the menu bar e4, the user terminal may display the mark selection page e1. At this time, the long-press operation performed by the user on the message “Want to hang out?” on the page E1 and the click operation performed on the “emoji” menu in the menu bar e4 may be collectively referred to as the foregoing second reply operation.

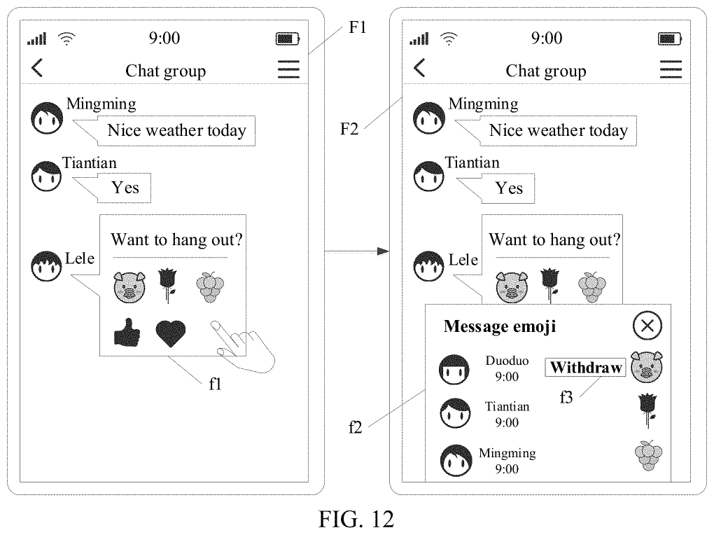

FIG. 12 is a schematic diagram of an interface of another terminal according to an embodiment of this application. As shown in FIG. 12, a page F1 and a page F2 are 2 pages of a user terminal. On the page F1, each user in a chat group may add a comment mark to each piece of session data on the page F1. Herein, 5 comment marks are added to an area f1 of the session data “Want to hang out?” on the page F1. The user terminal may display a mark browsing page in response to a mark browsing operation performed on a comment area, and output, on the mark browsing page, all target comment marks included in the comment area and a comment object corresponding to each target comment mark. The comment area may be an area of the first session data in which a comment mark is displayed, and comment marks displayed in the area of the first session data may all be referred to as a target comment marks.

For example, when the user clicks on a position of the comment mark in the area f1, the terminal may display a mark browsing page f2. The click operation performed by the user on the position of the comment mark in the area f1 is the foregoing mark browsing operation. The mark browsing page f2 includes each target comment mark, a comment object corresponding to each target comment mark, and an entry time of each target comment mark, and the comment object refers to a user adding the target comment mark. The mark browsing page f2 displays a target comment mark “pig head” added by the comment object “user Duoduo”, a target comment mark “flower” added by the comment object “user Tiantian”, and a target comment mark “grape” added by the comment object “user Mingming”. When swiping upwards on the mark browsing page f2, the user may browse more target comment marks and a comment object corresponding to each target comment mark. Herein, more target comment marks include other two target comment marks (that is, a target comment mark of like and a target comment mark of love).

The user terminal may delete the target comment mark in response to a withdrawal operation performed on the target comment mark. The user may be supported to withdraw a target comment mark added by the user within a specified time, for example, the user may be supported to withdraw a target comment mark added by the user within two minutes. As shown on the mark browsing page f2, when a time at which the user Duoduo adds the comment mark “pig head” is within a specified time, a “withdraw” button f3 may be displayed next to the comment mark “pig head” added by the user Duoduo on the mark browsing page f2. When the user Duoduo clicks on the “withdraw” button f3, the user terminal may delete the comment mark “pig head” added by the user Duoduo from the area f1.

When the first session data is text-type data, a set entry of a session set may be carried by the obtained latest second session data according to the above descriptions, and then the second session data carrying the set entry may be outputted on the primary session page. When the first session data is image-type data (such as a picture, an emoji, or a video), the set entry of the session set may be carried by the first session data, and the first session data carrying the set entry is outputted on the primary session page. For a specific process, refer to the following:

The user terminal may output, on the primary session page in response to the first reply operation performed on the first session data on the primary session page, the first session data carrying the set entry. Then, the user terminal may create the session set page in response to the expansion operation performed on the set entry that is carried by the first session data, the session set page being a sub-page that is independently displayed on the primary session page.

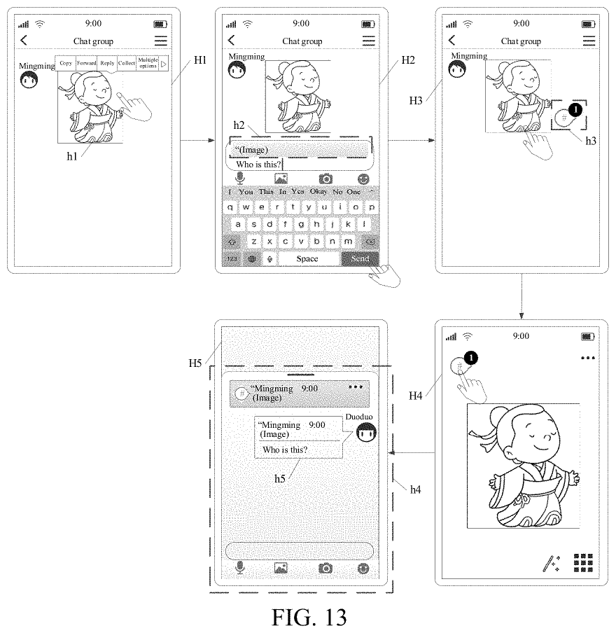

For a specific process, refer to FIG. 13. FIG. 13 is a schematic diagram of an interface of another terminal according to an embodiment of this application. A page H1, a page H2, a page H3, a page H4, and a page H5 are 5 pages of a user terminal. Session data h1 on the page H1 may be picture data or video data. Herein, an example in which the session data h1 is picture data is used for description. When the user Duoduo long-presses the session data h1, a menu bar pops up on the user terminal, and the menu bar includes a “reply” menu. When the user Duoduo clicks on the “reply” menu in the menu bar, the user terminal may display a session entry page including a to-be-replied object h2 (that is, a picture h1). As shown on the page H2, the user Duoduo may enter session data “Who is this?” on the session entry page of the page H2, and click on “send” on a keyboard on the session entry page. The user terminal may obtain the set entry h3, and the set entry h3 may be carried next to the picture h1 sent by the user Mingming, as shown on the page H3. This indicates that a session set is created for the picture h1, and the first session data in the session set is the picture h1.

The long-press operation performed on the session data h1, the click operation performed on the “reply” menu, and the click operation performed on “send” on the keyboard may be collectively referred to as the first reply operation, that is, the user terminal outputs, in response to the first reply operation, the first session data (that is, the picture h1) carrying the set entry (that is, the set entry h3) on the primary session page. A quantity of second session data included in the current session set may also be displayed on the set entry. As shown on the page H3, one piece of second session data is displayed on the set entry h3 on the page H3, because the session set corresponding to the first session data (that is, the picture h1) only has one piece of second session data (that is, “Who is this?” sent by the user Duoduo) at this time.

When the user Duoduo clicks on the picture h1 sent by the user Mingming on the page H3, the user terminal may enlarge the picture h1 for display, as shown on the page H4. In addition, the page H4 also has a set entry. When the user Duoduo clicks on the set entry on the page H4 (which may be referred to as an expansion operation performed on the set entry), the user terminal may create a session set page h4 corresponding to the picture h1, and the user terminal may display the created session set page h4 on a current page. It can be seen on the session set page h4 that the first session data is the picture sent by the user Mingming, and the first session data corresponds to one piece of second session data, that is, “Who is this?” sent by the user Duoduo.

In some embodiments, the user is supported to directly click on the set entry h3 on the page H3, and the user terminal also creates the session set page h4 and displays the session set page h4 on the page H3. The click operation performed by the user on the set entry h3 may be referred to as the expansion operation performed on the set entry carried by the first session data.

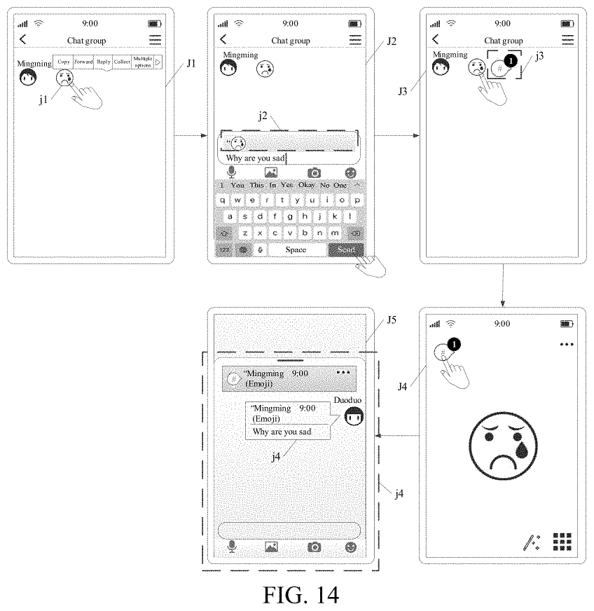

FIG. 14 is a schematic diagram of an interface of another terminal according to an embodiment of this application. Similar to the process described in FIG. 13, a page J1 includes an emoji j1 sent by the user Mingming. When the user long-presses the emoji j1, the user terminal may display a menu bar, the menu bar including a “reply” menu. When the user clicks on the “reply” menu, the user terminal may display a session entry page including a to-be-replied object j2 (that is, the emoji j1), as shown on the page J2. The user may enter session data “why are you sad” on the session entry page including the to-be-replied object j2 on the page J2, and click a send button of the keyboard on the session entry page. At this time, the emoji j1 is the first session data, that is, a session set corresponding to the emoji j1 that has been created. It can be seen that a set entry j3 is also carried next to the emoji sent by the user Mingming on a page J3.

When the user clicks on the emoji sent by the user Mingming on the page J3, the user terminal may enlarge the emoji sent by the user Mingming, as shown on a page J4. The page J4 also has a set entry. When the user clicks on the set entry on the page J4, the user terminal displays a session set page j4 corresponding to the emoji j1 on a current page. The first session data included on the session set page j4 is the emoji sent by the user Mingming, and the session set page j4 also includes the second session data “Why are you sad” sent by the user Duoduo. When the user clicks on the set entry j3 on the page J3, the session set page j4 may also be displayed on the page J3.

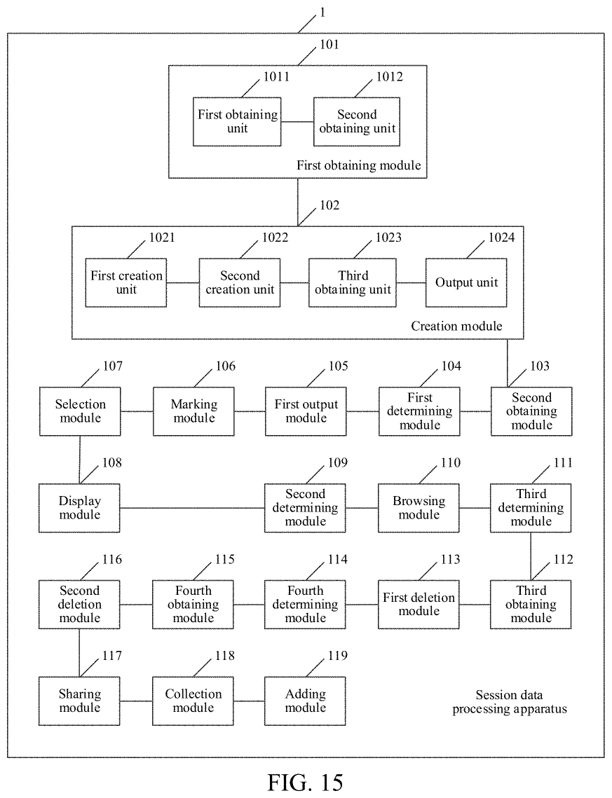

FIG. 15 is a schematic structural diagram of a session data processing apparatus according to an embodiment of this application. As shown in FIG. 15, the session data processing apparatus 1 may be applied to a user terminal, including: a first obtaining module 101 and a creation module 102.

The first obtaining module 101 is configured to: obtain, in response to a first reply operation performed on first session data on a primary session page, second session data that has a reply association relationship with the first session data, output a set entry of a session set corresponding to the first session data, and generate a set creation instruction for the first session data; and transmit the set creation instruction and the second session data to a server, so that the server determines the session set according to the set creation instruction, the first session data, and the second session data.

The creation module 102 is configured to: create, on the primary session page in response to an expansion operation performed on the set entry, a session set page corresponding to the session set, and transmit an obtaining instruction to the server; and receive the session set from the server, and output session data in the session set on the session set page, the session set including the first session data and at least one piece of second session data, and each piece of second session data having a reply association relationship with the first session data.

When the first session data is text-type data, the first obtaining module 101 includes:

a first obtaining unit 1011, configured to: obtain, in response to the first reply operation, first reply session data corresponding to the first session data to serve as the second session data, and output, on the primary session page, the first reply session data that carries the set entry; and

the creation module 102 includes:

a first creation unit 1021, configured to: create the session set page in response to the expansion operation performed on the set entry that is carried by the first reply session data, the session set page being a sub-page that is independently displayed on the primary session page.

When the first session data is image-type data, the first obtaining module 101 includes:

a second obtaining unit 1012, configured to: output, on the primary session page, the first session data that carries the set entry; and

the creation module 102 includes:

a second creation unit 1022, configured to: create the session set page in response to the expansion operation performed on the set entry that is carried by the first session data, the session set page being a sub-page that is independently displayed on the primary session page.

The session data processing apparatus 1 further includes a second obtaining module 103, a first determining module 104, and a first output module 105.

The second obtaining module 103 is configured to obtain an entry time of each piece of session data in the session set, the entry time being a time at which the session data is added to the session set.

The first determining module 104 is configured to determine second session data that has the last entry time as carrying session data.

The first output module 105 is configured to output, on the primary session page, the carrying session data that carries the set entry.

The first output module 105 is further configured to:

sequentially output, on the primary session page, each piece of second session data in the session set, an output time of each piece of second session data on the primary session page being the same as the entry time at which the second session data is added to the session set.

The session data processing apparatus 1 further includes a marking module 106, a selection module 107, and a display module 108.

The marking module 106 is configured to: display a mark selection page in response to a second reply operation performed on the first session data on the primary session page, the mark selection page including a plurality of comment marks, and the mark selection page being a sub-page that is independently displayed on the primary session page.

The selection module 107 is configured to: determine, in response to a selection operation performed on the comment mark on the mark selection page, the comment mark corresponding to the selection operation as a target comment mark.

The display module 108 is configured to: display the target comment mark in an area of the first session data.

The session data processing apparatus 1 further includes a second determining module 109 and a browsing module 110.

The second determining module 109 is configured to determine the area of the first session data in which the target comment mark is displayed as a comment area.

The browsing module 110 is configured to: display a mark browsing page in response to a mark browsing operation performed on the comment area, and output, on the mark browsing page, all target comment marks included in the comment area and a comment object corresponding to each target comment mark.

The session data processing apparatus 1 further includes a third determining module 111, a third obtaining module 112, and a first deletion module 113.

The third determining module 111 is configured to: determine, in response to a session trigger operation on the session set page, the first session data as a target reply object, and display a session entry page that has the target reply object.

The third obtaining module 112 is configured to: obtain second reply session data in response to a session entry operation on the session entry page that has the target reply object, the second reply session data including the target reply object.

The first deletion module 113 is configured to: output, on the primary session page, the second reply session data that carries the set entry.

The session data processing apparatus 1 further includes a fourth determining module 114, a fourth obtaining module 115, and a second deletion module 116.

The fourth determining module 114 is configured to: in response to a third reply operation performed on the second session data on the session set page, determine, the second session data on which the third reply operation is performed, as a selected reply object, and display a session entry page that has the selected reply object.

The fourth obtaining module 115 is configured to obtain third reply session data in response to a session entry operation on the session entry page that has the selected reply object, the third reply session data including the selected reply object.

The second deletion module 116 is configured to: output, on the primary session page, the third reply session data that carries the set entry.

The session data processing apparatus 1 further includes a sharing module 117, a collection module 118, and an adding module 119.

The sharing module 117 is configured to: generate sharing information in response to a sharing operation performed on the session set, and transmit the sharing information to a user terminal of a sharing object through the server, so that the user terminal of the sharing object outputs, in response to a display operation, a session display page corresponding to the session set, the session display page being used to display session data in the session set; or

the collection module 118 is configured to add the session set to a favorites bar in response to a collection operation performed on the session set; or

the adding module 119 is configured to determine the session set as history session set data, and adding the history session set data to a history session set list.

The creation module 1 includes a third obtaining unit 1023 and an output unit 1024.

The third obtaining unit 1023 is configured to obtain each piece of session data in the session set, and obtain a sender and a to-be-replied object that correspond to each piece of session data.

The output unit 1024 is configured to output each piece of session data on the session set page, each piece of session data on the session set page including the corresponding sender and the to-be-replied object.

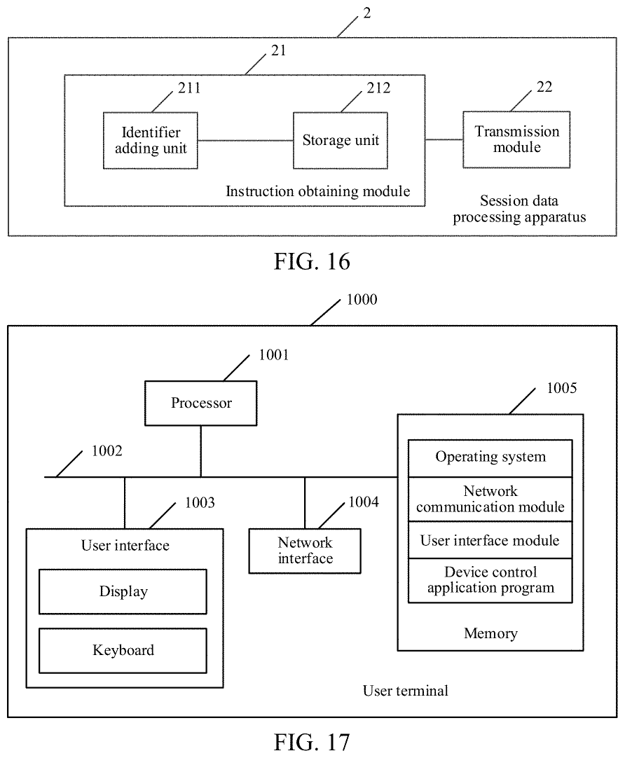

FIG. 16 is a schematic structural diagram of another session data processing apparatus according to an embodiment of this application. As shown in FIG. 16, the session data processing apparatus 2 may include: an instruction obtaining module 21 and a transmission module 22.

The instruction obtaining module 21 is configured to: obtain, from a user terminal, a set creation instruction for first session data on a primary session page and second session data that has a reply association relationship with the first session data, the user terminal obtaining the second session data in response to a first reply operation performed on the first session data, and outputting a set entry of a session set corresponding to the first session data; and determine the session set according to the set creation instruction, the first session data, and the second session data, the session set including the first session data and at least one piece of second session data, and each piece of second session data having a reply association relationship with the first session data.

The transmission module 22 is configured to transmit the session set to the user terminal according to an obtaining instruction for the session set when the obtaining instruction is obtained from the user terminal, the user terminal creating, on the primary session page in response to an expansion operation performed on the set entry, a session set page corresponding to the session set, and generating the obtaining instruction.

The instruction obtaining module 21 includes an identifier adding unit 211 and a storage unit 212.

The identifier adding unit 211 is configured to set identifier information of the first session data and the second session data separately, the identifier information including a session set identifier.

The storage unit 212 is configured to: determine the first session data and at least one piece of second session data that carry the same session set identifier as the session set, and store the session set for which the session set identifier is added in a database.

The transmission module 22 is further configured to:

pull, according to the session set identifier carried by the obtaining instruction, the session set corresponding to the session set identifier from the database, and transmit the pulled session set to the user terminal.

In this application, the term “unit” or “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

FIG. 17 is a schematic structural diagram of a user terminal according to an embodiment of this application. As shown in FIG. 17, a user terminal 1000 may include: a processor 1001, a network interface 1004, and a memory 1005. In addition, the user terminal 1000 may also include: a user interface 1003 and at least one communication bus 1002.

In the user terminal 1000 shown in FIG. 17, the network interface 1004 may provide a network communication function; the user interface 1003 is mainly configured to provide an input interface for a user; and the processor 1001 may be configured to call a device control application program stored in the memory 1005, to implement the session data processing method described in the embodiment corresponding to each one of FIG. 3A to FIG. 3C and FIG. 5.

In addition, an embodiment of this application also provides a computer-readable storage medium. The computer-readable storage medium stores computer programs executed by the session data processing apparatus 1 and the session data processing apparatus 2. The computer program includes program instructions. When executing the program instructions, the processor can implement the session data processing method described in the embodiment corresponding to each one of FIG. 2 and FIG. 5. Therefore, details are not repeated herein. In addition, the description of beneficial effects of the same method are not described herein again. For technical details that are not disclosed in the computer storage medium embodiments of this application, refer to the descriptions of the method embodiments of this application.

A person of ordinary skill in the art may understand that all or some of the procedures of the methods of the foregoing embodiments may be implemented by a computer program instructing relevant hardware. The program may be stored in a computer-readable storage medium. When the program is executed, the procedures of the foregoing method embodiments may be implemented. The foregoing storage medium may include a magnetic disc, an optical disc, a read-only memory (ROM), a random access memory (RAM), or the like.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A session data processing method performed by a computing device, the method comprising:
obtaining, in response to a first reply operation performed on first session data on a primary session page, second session data that has a reply association relationship with the first session data, and outputting a set entry of a session set corresponding to the first session data on the primary session page, and generating a set creation instruction for the first session data and the second session data;
transmitting the set creation instruction and the second session data to a server, wherein the server determines the session set according to the set creation instruction, the session set including the first session data and the second session data;
creating, in response to an expansion operation performed on the set entry, a session set page corresponding to the session set on the primary session page, and transmitting an instruction to the server for obtaining session information associated with the session set; and
receiving the session information associated with the session set from the server, and outputting session data in the session set on the session set page, the session set comprising the first session data and at least one piece of the second session data, and each piece of the second session data having a reply association relationship with the first session data.

2. The method according to claim 1, wherein when the first session data is text-type data, the obtaining, in response to a first reply operation performed on first session data on a primary session page, second session data that has a reply association relationship with the first session data, and outputting a set entry of a session set corresponding to the first session data on the primary session page comprises:
obtaining, in response to the first reply operation, first reply session data corresponding to the first session data to serve as the second session data, and outputting, on the primary session page, the first reply session data that carries the set entry; and
the creating, in response to an expansion operation performed on the set entry, a session set page corresponding to the session set on the primary session page comprises:
creating the session set page in response to the expansion operation performed on the set entry that is carried by the first reply session data, the session set page being a sub-page that is displayed on the primary session page.

3. The method according to claim 1, wherein when the first session data is image-type data, the outputting a set entry of a session set corresponding to the first session data comprises:
outputting, on the primary session page, the first session data that carries the set entry; and
the creating, in response to an expansion operation performed on the set entry, a session set page corresponding to the session set on the primary session page comprises:
creating the session set page, in response to the expansion operation performed on the set entry that is carried by the first session data, the session set page being a sub-page that is independently displayed on the primary session page.

4. The method according to claim 2, further comprising:
obtaining an entry time of each piece of session data in the session set, the entry time being a time at which the session data is added to the session set;
determining session data that has the last entry time as carrying session data; and
outputting, on the primary session page, the carrying session data that carries the set entry.

5. The method according to claim 4, further comprising:
sequentially outputting, on the primary session page, each piece of the second session data in the session set according to the entry time at which the second session data is added to the session set.

6. The method according to claim 1, further comprising:
displaying, in response to a second reply operation performed on the first session data on the primary session page, a mark selection page comprising a plurality of comment marks, and the mark selection page being a sub-page that is displayed on the primary session page;
determining, in response to a selection operation performed on one of the plurality of comment marks as a target comment mark on the mark selection page; and
displaying the target comment mark in an area of the first session data.

7. The method according to claim 1, further comprising:
determining, in response to a session trigger operation on the session set page, the first session data as a target reply object, and displaying a session entry page that has the target reply object;
obtaining second reply session data in response to a session entry operation on the session entry page that has the target reply object, the second reply session data comprising the target reply object; and
outputting, on the primary session page, the second reply session data that carries the set entry.

8. The method according to claim 1, further comprising:
in response to a third reply operation performed on the second session data on the session set page, determining, the second session data on which the third reply operation is performed, as a selected reply object, and displaying a session entry page that has the selected reply object;
obtaining third reply session data in response to a session entry operation on the session entry page that has the selected reply object, the third reply session data comprising the selected reply object; and
outputting, on the primary session page, the third reply session data that carries the set entry.

9. The method according to claim 1, further comprising:
generating sharing information in response to a sharing operation performed on the session set, and transmitting the sharing information to a second computing device of a sharing object through the server, so that the second computing device of the sharing object outputs, in response to a display operation, a session display page corresponding to the session set, the session display page being used to display session data in the session set.

10. The method according to claim 1, further comprising:
adding the session set to a favorites bar in response to a collection operation performed on the session set.

11. The method according to claim 1, further comprising:
determining the session set as history session set data, and adding the history session set data to a history session set list.

12. The method according to claim 1, wherein the receiving the session information associated with the session set from the server, and outputting session data in the session set on the session set page comprises:
obtaining each piece of session data in the session set, and obtaining a sender and a to-be-replied object that correspond to each piece of session data; and
outputting each piece of session data on the session set page, each piece of session data on the session set page comprising the corresponding sender and the to-be-replied object.

13. A computing device, comprising: a processor and a memory;
the processor being connected to the memory, the memory being configured to store a plurality of computer programs that, when executed by the processor, cause the computing device to perform a plurality of operations including:
obtaining, in response to a first reply operation performed on first session data on a primary session page, second session data that has a reply association relationship with the first session data, and outputting a set entry of a session set corresponding to the first session data on the primary session page, and generating a set creation instruction for the first session data and the second session data;
transmitting the set creation instruction and the second session data to a server, wherein the server determines the session set according to the set creation instruction, the session set including the first session data and the second session data;
creating, in response to an expansion operation performed on the set entry, a session set page corresponding to the session set on the primary session page, and transmitting an instruction to the server for obtaining session information associated with the session set; and
receiving the session information associated with the session set from the server, and outputting session data in the session set on the session set page, the session set comprising the first session data and at least one piece of the second session data, and each piece of the second session data having a reply association relationship with the first session data.

14. The computing device according to claim 13, wherein the plurality of operations further comprise:
displaying, in response to a second reply operation performed on the first session data on the primary session page, a mark selection page comprising a plurality of comment marks, and the mark selection page being a sub-page that is displayed on the primary session page;
determining, in response to a selection operation performed on one of the plurality of comment marks as a target comment mark on the mark selection page; and
displaying the target comment mark in an area of the first session data.

15. The computing device according to claim 13, wherein the plurality of operations further comprise:
determining, in response to a session trigger operation on the session set page, the first session data as a target reply object, and displaying a session entry page that has the target reply object;
obtaining second reply session data in response to a session entry operation on the session entry page that has the target reply object, the second reply session data comprising the target reply object; and
outputting, on the primary session page, the second reply session data that carries the set entry.

16. The computing device according to claim 13, wherein the plurality of operations further comprise:
in response to a third reply operation performed on the second session data on the session set page, determining, the second session data on which the third reply operation is performed, as a selected reply object, and displaying a session entry page that has the selected reply object;
obtaining third reply session data in response to a session entry operation on the session entry page that has the selected reply object, the third reply session data comprising the selected reply object; and
outputting, on the primary session page, the third reply session data that carries the set entry.

17. The computing device according to claim 13, wherein the plurality of operations further comprise:
generating sharing information in response to a sharing operation performed on the session set, and transmitting the sharing information to a second computing device of a sharing object through the server, so that the second computing device of the sharing object outputs, in response to a display operation, a session display page corresponding to the session set, the session display page being used to display session data in the session set.

18. The computing device according to claim 13, wherein the plurality of operations further comprise:
adding the session set to a favorites bar in response to a collection operation performed on the session set.

19. The computing device according to claim 13, wherein the plurality of operations further comprise:
determining the session set as history session set data, and adding the history session set data to a history session set list.

20. A non-transitory computer-readable storage medium, storing a plurality of computer programs, the computer programs comprising program instructions that, when executed by a processor of a computing device, cause the computing device to perform a plurality of operations including:
obtaining, in response to a first reply operation performed on first session data on a primary session page, second session data that has a reply association relationship with the first session data, and outputting a set entry of a session set corresponding to the first session data on the primary session page, and generating a set creation instruction for the first session data and the second session data;
transmitting the set creation instruction and the second session data to a server, wherein the server determines the session set according to the set creation instruction, the session set including the first session data and the second session data;
creating, in response to an expansion operation performed on the set entry, a session set page corresponding to the session set on the primary session page, and transmitting an instruction to the server for obtaining session information associated with the session set; and
receiving the session information associated with the session set from the server, and outputting session data in the session set on the session set page, the session set comprising the first session data and at least one piece of the second session data, and each piece of the second session data having a reply association relationship with the first session data.
